(19) United States
(12) Patent Application Publication
(10) Pub. No.: US 2026/0179312 A1
(43) Pub. Date: Jun. 25, 2026

(54) IMAGE PROCESSING APPARATUS, IMAGE PROCESSING METHOD, AND MEDIUM

(71) Applicant: CANON KABUSHIKI KAISHA, Tokyo (JP)

(72) Inventor: Kazufumi ONUMA, Kanagawa (JP)

(21) Appl. No.: 19/417,450

(22) Filed: Dec. 12, 2025

(30) Foreign Application Priority Data
Dec. 20, 2024 (JP) 2024-225569

(51) Int. Cl. G06T 15/20; G06T 1/00; G06T 19/20

(52) U.S. Cl. CPC G06T 15/205; G06T 1/0021; G06T 19/20; G06T 2219/2012; G06T 2219/2021

(57) ABSTRACT

An image processing apparatus is provided. The apparatus obtains a plurality of pieces of information. One piece of information indicates a time corresponding to an object, a position of a virtual viewpoint, and a line-of-sight direction from the virtual viewpoint. The apparatus determines whether or not the plurality of pieces of information satisfy a predetermined condition. The apparatus generates a virtual viewpoint image corresponding to the virtual viewpoint and including an object corresponding to the time based on each of the plurality of pieces of information such that a virtual viewpoint image to be generated changes in accordance with a result of the determination.

### BACKGROUND

### Field of the Technology

The present disclosure relates to an image processing apparatus, an image processing method, and a medium, in particular, a technology for generating a virtual viewpoint video.

### Description of the Related Art

There is a system that generates a virtual viewpoint video from a virtual viewpoint designated by a user based on images captured by a plurality of cameras. In the image processing system described in Japanese Patent Laid-Open No. 2017-211828, an image processing apparatus extracts a foreground image from a captured image of a subject obtained by a camera, by comparison with a background. Then, an image generation apparatus estimates a three-dimensional shape of the subject based on the foreground images obtained from the plurality of captured images. In this system, time and viewpoint can be arbitrarily operated. Therefore, the subject at a certain time can be viewed from an arbitrary viewpoint.

A three-dimensional reconstruction technology for estimating a three-dimensional shape of a subject using captured images obtained by capturing a stationary subject from a plurality of directions has become widespread. Known three-dimensional reconstruction technologies include photogrammetry and NeRF. These three-dimensional reconstruction technologies have become easily available using applications or Web services.

### SUMMARY

Use of a system that generates a virtual viewpoint image that can operate time and viewpoint enables a user to easily acquire images from a plurality of viewpoints of a subject at a specific time. There is a possibility that the user reconstructs a three-dimensional shape of the subject using the image thus obtained and the three-dimensional reconstruction technology.

One embodiment of the present disclosure can make it difficult to estimate a three-dimensional shape of a subject based on a generated virtual viewpoint image in a technology of generating a virtual viewpoint image of the subject.

According to an embodiment, an image processing apparatus comprises one or more memories storing instructions and one or more processors that execute the instructions to: obtain a plurality of pieces of information, wherein one piece of information indicates a time corresponding to an object, a position of a virtual viewpoint, and a line-of-sight direction from the virtual viewpoint; determine whether or not the plurality of pieces of information satisfy a predetermined condition; and generate a virtual viewpoint image corresponding to the virtual viewpoint and including an object corresponding to the time based on each of the plurality of pieces of information such that a virtual viewpoint image to be generated changes in accordance with a result of the determination.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram of an image processing apparatus according to one embodiment.

FIG. 2 is a flowchart of the image processing method according to one embodiment.

FIG. 3 is a view illustrating an example of a virtual viewpoint video including a blocker object.

FIG. 4 is a view illustrating an example of a three-dimensional reconstruction result based on a video including a blocker object.

FIG. 5 is a view illustrating an example of changing a positional relationship between a subject and a background.

FIG. 6 is a block diagram illustrating a configuration example of hardware of a computer.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

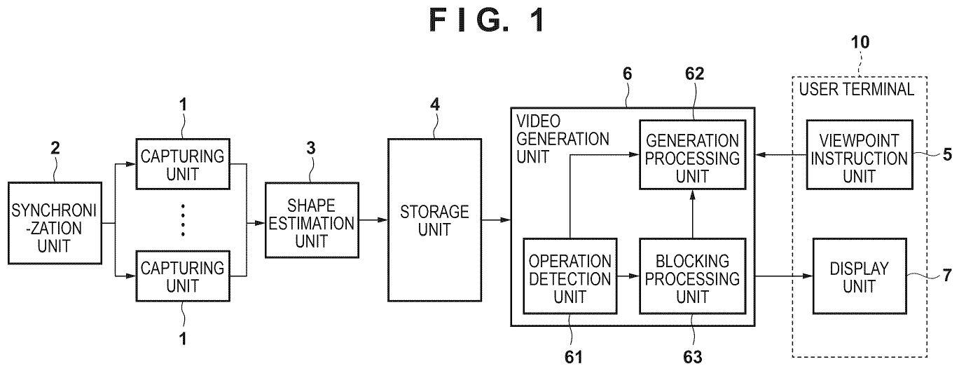

FIG. 1 illustrates an example of the configuration of the image processing system according to one embodiment. In the present embodiment, the image processing system includes an image processing apparatus and a user terminal 10. The image processing apparatus according to the present embodiment generates a virtual viewpoint image. The image processing apparatus according to the present embodiment can generate a virtual viewpoint video including a plurality of frames each corresponding to a virtual viewpoint image. The image processing apparatus according to the present embodiment includes a synchronization unit 2, a shape estimation unit 3, a storage unit 4, and a video generation unit 6. Note that the image processing apparatus may include a plurality of the video generation units 6. In this case, the plurality of video generation units 6 may be connected to one storage unit 4.

The user terminal 10 includes a viewpoint instruction unit 5 and a display unit 7. Note that the user terminal 10 may include a storage unit (not illustrated) that stores virtual viewpoint images acquired by the user terminal 10.

An outline of the operation performed by each configuration of the image processing system according to one embodiment will be described. First, a plurality of capturing units 1 perform capturing in synchronization with each other based on a synchronization signal from the synchronization unit 2. In this manner, the plurality of capturing units 1 generate images (texture images) from a plurality of viewpoints. The capturing unit 1 outputs a texture image obtained by shooting to the shape estimation unit 3. Note that the plurality of capturing units 1 can be installed so as to surround a shooting region where the subject is positioned. Such an arrangement enables the plurality of capturing units 1 to shoot the subject from a plurality of directions.

The shape estimation unit 3 estimates a three-dimensional shape of the subject using the texture image input from the capturing unit 1. For example, the shape estimation unit 3 extracts a silhouette of the subject from texture images from a plurality of viewpoints. Then, the shape estimation unit 3 generates data indicating the three-dimensional shape of the subject using a volume intersection method or the like based on the silhouettes of the subject from the plurality of viewpoints thus obtained. Furthermore, the shape estimation unit 3 outputs data indicating the generated three-dimensional shape and the texture image to the storage unit 4.

Here, the subject is an object that is a target of three-dimensional shape generation. Examples of subject include a person, an article handled by a person, and an animal. Furthermore, the subject may be a virtual object generated using CG or CAD technology. In the present specification, these subjects are called foreground objects.

The storage unit 4 stores data (material data) used for generation of the virtual viewpoint video. The material data includes, for example, texture images and three-dimensional shape data of the foreground object input from the shape estimation unit 3. The storage unit 4 stores the material data in association with information regarding the time. For example, the material data for a specific capturing time can include a texture image at the specific capturing time and three-dimensional shape data for the specific capturing time. The texture image for the specific capturing time may be a captured image obtained by each of the plurality of capturing units 1 at the specific capturing time. The three-dimensional shape data for the specific capturing time may be data representing the three-dimensional shape of the subject estimated based on the captured image obtained by each of the plurality of capturing units 1 at the specific capturing time. The storage unit 4 can store material data corresponding to each of the plurality of times. The storage unit 4 stores camera parameters such as the position, attitude, and optical characteristics of each of the plurality of capturing units 1.

Furthermore, the storage unit 4 stores background data used for background generation of the virtual viewpoint video. In the present specification, an object serving as a background is called a background object. The background data includes three-dimensional shape data of the background object and a background texture image. In one embodiment, the same background data is used to generate a virtual viewpoint image regardless of the time information indicated by the operation information. The storage unit 4 may store other data such as audio data.

The user terminal 10 includes the viewpoint instruction unit 5 and the display unit 7. The user can operate a virtual viewpoint and a reproduction target time using the user terminal 10. The user can browse the virtual viewpoint video on the user terminal 10. The viewpoint instruction unit 5 can include a user interface such as a touch panel, a joystick, or a jog dial, for example. The display unit 7 may be a display. On the display unit 7, a virtual viewpoint video created by the video generation unit 6 described later is displayed as necessary.

The viewpoint instruction unit 5 generates information indicating a time corresponding to the foreground object, the position of a virtual viewpoint, and the line-of-sight direction from the virtual viewpoint, based on the input to the user interface. The viewpoint instruction unit 5 outputs the generated information to the video generation unit 6. The time corresponding to the foreground object indicates a time associated with the material data used for generation of the virtual viewpoint image. That is, by designating the time corresponding to the foreground object, a virtual viewpoint image in accordance with a texture image of the subject at the designated time and the three-dimensional data of the subject based on a captured image obtained at the designated time is generated. In the present specification, information indicating the time corresponding to the foreground object is called time information. In the present specification, information for designating a virtual viewpoint is called virtual viewpoint information. The virtual viewpoint information indicates the position of the virtual viewpoint and the line-of-sight direction from the virtual viewpoint. The virtual viewpoint information can include information (corresponding to external parameters of the camera) indicating the position of the virtual viewpoint and the line-of-sight direction (or attitude), and information (corresponding to internal parameters of the camera) indicating the focal length and the angle of view of the virtual viewpoint.

For example, the viewpoint instruction unit 5 can generate operation information indicating the time of the virtual viewpoint image and the operation of the viewpoint. The operation information can include virtual viewpoint information. Also, the operation information can include time information. In the present specification, the time corresponding to the foreground object indicated by the time information may be called the time of the virtual viewpoint image. The virtual viewpoint image at a specific time includes a foreground object corresponding to this time. In this manner, the operation information can include time information for designating the capturing time to be reproduced. In the present embodiment, the user can operate the time and viewpoint of the virtual viewpoint image such that at least one of the time and viewpoint of the virtual viewpoint image changes over time. That is, the viewpoint instruction unit 5 can generate a plurality of pieces of information indicating the time corresponding to the foreground object, the position of the virtual viewpoint, and the line-of-sight direction from the virtual viewpoint. In this manner, the viewpoint instruction unit 5 can generate operation information indicating a plurality of combinations of the virtual viewpoint information and the time information.

The video generation unit 6 generates a virtual viewpoint image based on a plurality of pieces of information indicating the time corresponding to the foreground object, the position of the virtual viewpoint, and the line-of-sight direction from the virtual viewpoint. Specifically, the video generation unit 6 generates a virtual viewpoint image corresponding to the virtual viewpoint and including an object corresponding to the time. The video generation unit 6 can generate a virtual viewpoint image based on the operation information. That is, the video generation unit 6 can generate a virtual viewpoint image including an image from each designated viewpoint of the foreground object corresponding to each designated time in accordance with the operation information. Specifically, the video generation unit 6 can generate a virtual viewpoint image from a designated viewpoint corresponding to the virtual viewpoint information included in the operation information at the designated time corresponding to the time information included in the operation information. The generation method of a virtual viewpoint image is not particularly limited. For example, the video generation unit 6 can acquire material data corresponding to the designated time indicated by the time information from the storage unit 4 based on the time information included in the operation information that is input. Then, the video generation unit 6 can generate a virtual viewpoint video at a virtual viewpoint indicated by the virtual viewpoint information included in the operation information by using the three-dimensional shape data of the foreground object and the plurality of texture images of the foreground object included in the acquired material data. For example, with reference to the camera parameters of the capturing unit 1, the video generation unit 6 can map the texture image onto a three-dimensional shape model of the foreground object represented by the three-dimensional shape data. The video generation unit 6 can arrange the three-dimensional shape model in a virtual space. Then, the video generation unit 6 can generate a virtual viewpoint image by rendering an image of the virtual space including the foreground object viewed from the virtual viewpoint.

The video generation unit 6 can generate a virtual viewpoint image from the designated viewpoints of the foreground object and the background object by further using three-dimensional shape data of the background object. For example, the video generation unit 6 can acquire the background data stored in the storage unit 4. At this time, the video generation unit 6 can map the background texture image onto the three-dimensional shape model of the background object represented by the three-dimensional shape data included in the background data. In this manner, the video generation unit 6 can render the three-dimensional shape model of the foreground object and the three-dimensional shape model of the background object together. The video generation unit 6 can output the virtual viewpoint image thus generated to the display unit 7.

The video generation unit 6 can sequentially generate virtual viewpoint images respectively corresponding to combinations of the virtual viewpoint information and the time information. The video generation unit 6 can output, to the display unit 7, the virtual viewpoint video including the plurality of virtual viewpoint images thus generated. For example, the operation information can designate advancing time along a time axis. At this time, the virtual viewpoint image at each time is displayed on the display unit 7. In this manner, the virtual viewpoint video changing along the time axis is reproduced on the display unit 7.

The video generation unit 6 further determines whether or not a plurality of pieces of information indicating the time corresponding to the foreground object, the position of the virtual viewpoint, and the line-of-sight direction from the virtual viewpoint satisfy a predetermined condition. Then, the video generation unit 6 performs control to change the virtual viewpoint image to be generated in accordance with a determination result. For example, the video generation unit 6 can perform control to change the virtual viewpoint image to be generated depending on whether or not the operation at the time indicated by the operation information satisfies a predetermined condition. The video generation unit 6 makes a change to the virtual viewpoint image such that reconstruction of a three-dimensional shape of the foreground object based on the virtual viewpoint image becomes more difficult in accordance with the determination result that the plurality of pieces of information satisfy the predetermined condition. On the other hand, in one embodiment, in a case where the plurality of pieces of information do not satisfy the predetermined condition, such a change is not made. Therefore, in a case where the plurality of pieces of information do not satisfy the predetermined condition, it is possible to block quality reduction of the virtual viewpoint image.

The video generation unit 6 includes an operation detection unit 61, a generation processing unit 62, and a blocking processing unit 63. The operation detection unit 61 acquires a plurality of pieces of information indicating the time corresponding to the object, the position of the virtual viewpoint, and the line-of-sight direction from the virtual viewpoint. Then, it is determined whether or not the plurality of pieces of information satisfy a predetermined condition. For example, the operation detection unit 61 acquires operation information and determines whether or not the operation at the time indicated by the operation information satisfies a predetermined condition. In this manner, the operation detection unit 61 can monitor the time information and detect that a specific operation regarding the time has been performed. The operation detection unit 61 outputs the detection result to the blocking processing unit 63.

The generation processing unit 62 generates a virtual viewpoint image including an object corresponding to a virtual viewpoint and corresponding to a time based on each of the plurality of pieces of information. For example, the generation processing unit 62 can sequentially generate virtual viewpoint images including images from respective designated viewpoints of the foreground object corresponding to respective designated times in accordance with the operation information. The generation processing unit 62 can generate the virtual viewpoint image by the above method.

The blocking processing unit 63 performs control to make reconstruction of the three-dimensional shape of the foreground object based on the virtual viewpoint image more difficult. In one embodiment, the blocking processing unit 63 can add a blocking display with respect to the virtual viewpoint image generated by the generation processing unit 62 based on the output of the operation detection unit 61. This blocking display is added such that reconstruction of the three-dimensional shape of the foreground object based on the virtual viewpoint image output from the video generation unit 6 becomes more difficult. In this case, the video generation unit 6 outputs a virtual viewpoint image added with the blocking display. A specific example of the blocking display will be described later.

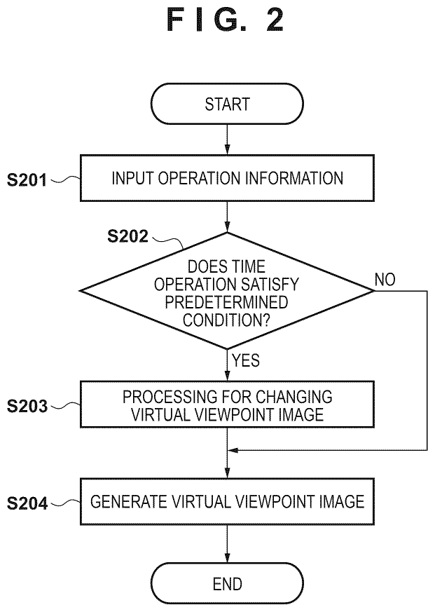

Next, processing performed by the image processing system according to the present embodiment will be described with reference to the flowchart of FIG. 2.

In S201, the user operates the viewpoint instruction unit 5 in order to operate the virtual viewpoint and the time. Then, the viewpoint instruction unit 5 inputs operation information in accordance with the user operation to the video generation unit 6.

In S202, the operation detection unit 61 acquires information indicating the time corresponding to the object, the position of the virtual viewpoint, and the line-of-sight direction from the virtual viewpoint. Then, the operation detection unit 61 determines whether or not the plurality of pieces of information satisfy a predetermined condition. The operation detection unit 61 may determine whether or not a predetermined number of pieces of information acquired most recently satisfy a predetermined condition. The predetermined condition is not particularly limited. The predetermined condition may be a condition regarding a change in time indicated by the plurality of pieces of information. For example, the predetermined condition may be a condition regarding an operation of time indicated by the operation information. The predetermined condition may be satisfied in a case where an operation for facilitating the reconstruction of the three-dimensional shape of the foreground object based on the virtual viewpoint image is performed. For example, there is a possibility that the three-dimensional shape of a foreground object can be easily reconstructed by generating virtual viewpoint images of the foreground object at the same or almost the same time from a plurality of virtual viewpoints. In a case where the plurality of pieces of information satisfy the predetermined condition, the processing proceeds to S203. Otherwise, the processing proceeds to S204.

For example, the predetermined condition may be satisfied in a case where the time is stopped. That is, the predetermined condition can include pausing reproduction. The operation detection unit 61 can detect pausing of reproduction based on the time information included in the operation information. For example, in a case where the times indicated by the predetermined number of pieces of information acquired most recently coincide with each other, the operation detection unit 61 can determine that reproduction is paused. Such an operation enables the user to generate virtual viewpoint images of the foreground object from a plurality of virtual viewpoints at the same time. As another example, the predetermined condition may be satisfied in a case where the time is changed at a speed of a threshold or less. For example, the predetermined condition can include performing reproduction at an extremely low speed at which the subject does not substantially move. Such an operation enables the user to generate virtual viewpoint images from a plurality of virtual viewpoints of the foreground object substantially not moving.

The predetermined condition may be satisfied in a case where the same time is repeated. That is, the predetermined condition can include repeatedly performing reproduction at the same time or in the same time period. The operation of the time satisfying the predetermined condition may be an operation of repeating the same time or the same time period a predetermined number of times or more. The predetermined number of times is not particularly limited, and may be an arbitrary number of times of two or more times. The operation detection unit 61 can record a generation history of the virtual viewpoint image. This generation history can include time information corresponding to the virtual viewpoint image indicated by the operation information. By referring to such a generation history, the operation detection unit 61 can detect that reproduction is repeatedly performed at the same time or in the same time period. The user can generate virtual viewpoint images from a plurality of virtual viewpoints of the foreground object at this time by performing reproduction so as to repeat the same time while changing the virtual viewpoint each time reproduction is performed.

In S203, the blocking processing unit 63 performs processing of changing the virtual viewpoint image displayed in S204. In the present embodiment, the blocking processing unit 63 adds an object. In the present specification, the additional object added in this manner is called a blocker object. The blocking processing unit 63 can add a three-dimensional object as a blocker object. In this case, in addition to the foreground object included in the material data corresponding to the designated time of the display target, a blocker object is arranged in the virtual space.

The blocker object may be an object that changes in accordance with the position of the virtual viewpoint. For example, the blocker object may be an object whose color, shape, or arrangement changes in accordance with the position of the virtual viewpoint. In the present specification, the processing in accordance with the position of the virtual viewpoint includes processing in accordance with the direction of the virtual viewpoint. The direction of the virtual viewpoint may be an orientation of an optical axis center of the virtual viewpoint (i.e., the line-of-sight direction) or an orientation from the virtual viewpoint to an object such as a blocker object. For example, the blocker object may be an object whose color, shape, or arrangement changes in accordance with the direction of the virtual viewpoint. The color, shape, or arrangement of the blocker object may be different for each direction of the virtual viewpoint.

In one embodiment, the color of the blocker object in a virtual viewpoint image changes in accordance with the position of a designated viewpoint. For example, the blocker object may have surface characteristics in which the color changes in accordance with the position of a designated viewpoint. In one embodiment, the blocker object is an object including a mirror surface. A reflected image appearing on an object including a mirror surface changes depending on a viewing direction. Therefore, the color of the surface of the object including a mirror surface changes in accordance with the position of the virtual viewpoint. It is difficult to estimate the shape of an object including such a mirror surface by photogrammetry or the like. FIG. 4 illustrates an example of an estimation result of a three-dimensional shape of an object including a mirror surface by photogrammetry. In FIG. 4, an object including a mirror surface is detected as an object 430 having an irregular shape. In this manner, the estimation result of an object including a mirror surface is inaccurate. The object 430 having an irregular shape attaches to a foreground object 410 such as a person and a background object 420. Due to this influence, as illustrated in portions 411 and 412, the shape of an object to be estimated is also inaccurate. Furthermore, color information of the object thus attached is also inaccurate. Furthermore, an estimation result of the shape of the object in a portion shielded by the object is also inaccurate. In this manner, by adding the blocker object, reconstruction of the three-dimensional shape of the foreground object based on the virtual viewpoint image that is generated becomes more difficult. On the other hand, a sense of incongruity given to the user viewing a virtual viewpoint image by adding an object including a mirror surface is small.

The blocker object may be a semi-transparent object. The color of such an object changes in accordance with the color of the object positioned behind. Therefore, the color of such an object also changes in accordance with the position of the virtual viewpoint.

The type of blocker object is not particularly limited. The blocker object may be, for example, an object having an unrealistic characteristic different from an object existing in real space. For example, the color, shape, or arrangement of the blocker object in a virtual space may vary in accordance with the position of a designated viewpoint or for each virtual viewpoint image to be generated. The blocking processing unit 63 may set the color, shape, or arrangement of the blocker object such that the color, shape, or arrangement of the blocker object changes in accordance with the position of the virtual viewpoint. In a case where the position of the virtual viewpoint changes, the blocking processing unit 63 can change the color, shape, or arrangement of the blocker object. Note that in the present specification, changing the color of an object includes changing transparency of the object.

In another example, the blocking processing unit 63 may randomly change the color, shape, or arrangement of the blocker object. For example, the blocking processing unit 63 can change the color, shape, or arrangement of the blocker object for each virtual viewpoint image to be generated. In the present embodiment, the blocking processing unit 63 changes the color, shape, or arrangement of an object arranged in a virtual space before rendering processing for generating a virtual viewpoint image. In this manner, the blocker object can have an unrealistic characteristic that the color, shape, or arrangement varies at the same designated time.

For example, the blocking processing unit 63 can change a texture image of a blocker object in accordance with the position of the virtual viewpoint. The blocking processing unit 63 can change the color of an object in accordance with the position of the virtual viewpoint. For example, the blocking processing unit 63 can set a color mixture of a plurality of colors as the color of an object. In this case, the weight of each of the plurality of colors can be changed in accordance with the position of the virtual viewpoint. The blocking processing unit 63 can change the transparency of an object in accordance with the position of the virtual viewpoint. The blocking processing unit 63 may deform a blocker object in accordance with the position of the virtual viewpoint. For example, the blocking processing unit 63 may change the size of a blocker object in accordance with the position of the virtual viewpoint. The blocking processing unit 63 may translate the position of a blocker object or rotate a blocker object in accordance with the position of the virtual viewpoint. For example, the blocking processing unit 63 can arrange a blocker object such that a specific surface of the blocker object faces a designated viewpoint. That is, a blocker object may rotate such that a specific surface of the blocker object faces the virtual viewpoint. For example, the blocker object may be a billboard-type object including a texture image. The blocking processing unit 63 can set the orientation of this object such that the texture image faces the virtual viewpoint side at all times.

The blocker object may have a surface visible from an internal side of the blocker object and invisible from an external side of the blocker object. For example, only one side of a mesh indicating a three-dimensional shape of a blocker object may be a non-display surface. Specifically, the mesh constituting the blocker object may be set such that a normal direction (front surface) is in an inward orientation and a back surface is non-displayed. In a virtual viewpoint image, the surface on a side close to the virtual viewpoint of such a blocker object is not displayed, and only the surface on a side far from the virtual viewpoint is displayed.

These objects have display characteristics that are impossible in reality. Therefore, in a case where a three-dimensional reconstruction technology such as photogrammetry or NeRF is used, it is expected that the estimation result of the foreground object becomes inaccurate. Also in a case where a smaller number of blocker objects or smaller blocker objects are arranged, estimation of the three-dimensional shapes of the objects is expected to be difficult. Therefore, it is possible to reduce an influence on a user experience of the user viewing the virtual viewpoint image.

On the other hand, the blocker object may be a normal object whose color or shape does not change in accordance with the position of the virtual viewpoint. By arranging such an object in the vicinity of a foreground object, it is expected that a part of the foreground object is hidden by the blocker object. Therefore, it becomes more difficult to reconstruct the three-dimensional shape of the object based on the generated virtual viewpoint image.

The blocker object may be prepared in advance. For example, the shape, color, or texture of a blocker object may be set in advance. On the other hand, the blocking processing unit 63 may change the number of blocker objects. For example, the blocking processing unit 63 may add a blocker object in accordance with the situation. The blocking processing unit 63 may change the arrangement of the blocker object in accordance with the foreground object. For example, the blocking processing unit 63 can change the arrangement of the blocker object in a virtual space in accordance with the size, number (e.g., the number of subject persons), or position of the foreground object. As a specific example, the blocking processing unit 63 can arrange a plurality of blocker objects so as to surround the foreground object. The blocking processing unit 63 may arrange a blocker object between the foreground object and the virtual viewpoint. The blocking processing unit 63 may change the size of the blocker object depending on the angle of view of the virtual viewpoint or the distance between the virtual viewpoint and the foreground object.

Furthermore, the blocking processing unit 63 may change the number or size of the blocker objects in accordance with a time during which the time is stopped, a time during which the time is changing at a speed of a threshold or less, or the number of repetitions of the same time. For example, the longer the time during which the time is stopped, the larger the number of blocker objects may be or the larger the blocker objects may be. The blocking processing unit 63 may change the number or size of the blocker objects in accordance with a movement distance of the virtual viewpoint while the time is stopped or the time is changing at a speed of a threshold or less.

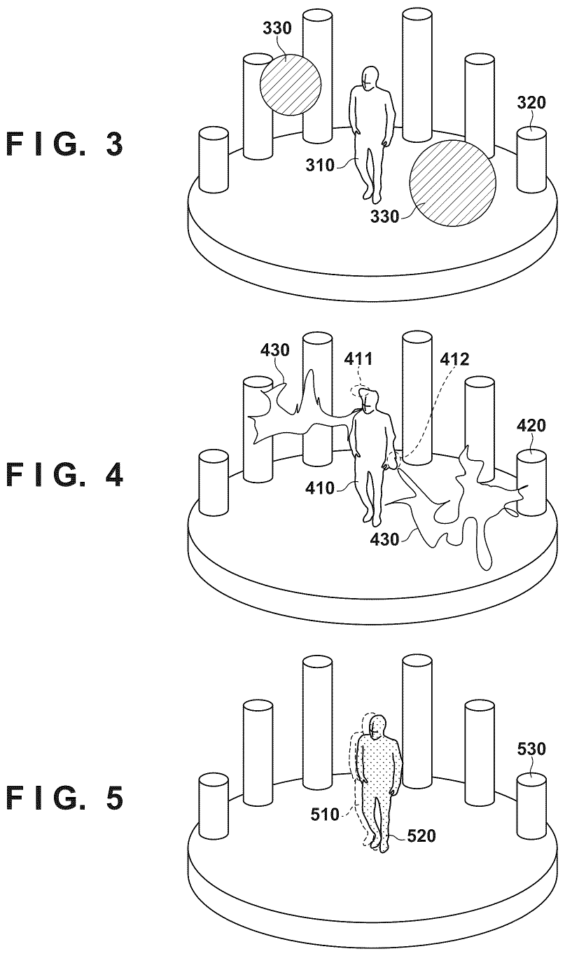

In S204, the generation processing unit 62 generates a virtual viewpoint image including an image from a designated viewpoint of an object corresponding to a designated time as described above. In a case where it is determined that the plurality of pieces of information do not satisfy the predetermined condition, the generation processing unit 62 can generate a virtual viewpoint image of a foreground object included in material data corresponding to the designated time of the display target. On the other hand, in a case where it is determined that the plurality of pieces of information satisfy the predetermined condition, both the foreground object included in the material data corresponding to the designated time of the display target and the blocker object added by the blocking processing unit 63 in S203 are arranged in a virtual space. Then, the generation processing unit 62 generates a virtual viewpoint image of such a virtual space. FIG. 3 illustrates an example of a virtual viewpoint image generated by the generation processing unit 62 in a case where it is determined that the plurality of pieces of information satisfy the predetermined condition. The virtual viewpoint image illustrated in FIG. 3 includes a blocker object 330 in addition to a foreground object 310 and a background object 320.

Furthermore, the generation processing unit 62 outputs the generated virtual viewpoint image to the display unit 7. In the display unit 7, a virtual viewpoint image corresponding to the time information and the virtual viewpoint information is generated.

By repeating the processing of S201 to S204, the video generation unit 6 generates a plurality of virtual viewpoint images, that is, virtual viewpoint videos, in accordance with a plurality of pieces of information indicating the time corresponding to the object, the position of the virtual viewpoint, and the line-of-sight direction from the virtual viewpoint.

According to the present embodiment, the video generation unit 6 can generate a virtual viewpoint image in which a blocker object is arranged. As a result, in a case where the user creates a virtual viewpoint video while operating the virtual viewpoint and generates a three-dimensional shape model of a foreground object using the virtual viewpoint video, the accuracy of the three-dimensional shape model decreases.

### Other Embodiments

In the above-described embodiment, in order to make reconstruction of the three-dimensional shape of the foreground object difficult, the blocking processing unit 63 arranges the blocker object in the virtual space. However, it is not essential to use the blocker object in order to make reconstruction of the three-dimensional shape of the foreground object difficult. The blocking processing unit 63 may employ another method.

For example, the blocking processing unit 63 may superimpose an additional image (blocker image) with respect to a virtual viewpoint image in accordance with determining that the plurality of pieces of information satisfy the predetermined condition. For example, the blocking processing unit 63 can generate a blocker image in S203. Then, in S204, the generation processing unit 62 can superimpose the blocker image with respect to the virtual viewpoint image generated using the material data. The type of blocker image is not particularly limited. The blocker image may be, for example, a watermark image. Such a watermark image is less likely to be visually recognized by the user, but is expected to affect reconstruction of the three-dimensional shape of the foreground object using a virtual viewpoint video. However, the blocker image may be an image visually recognizable by the user. Such a blocker image may be different in accordance with the position of the virtual viewpoint or for each virtual viewpoint image to be generated.

Regardless of whether or not the plurality of pieces of information satisfy the predetermined condition, the generation processing unit 62 can superimpose the foreground image or the background image with respect to the generated virtual viewpoint image. In this case, the blocking processing unit 63 may change the color, shape, or position of the foreground image or the background image in accordance with determining that the plurality of pieces of information satisfy the predetermined condition. For example, the blocking processing unit 63 may change the color, shape, or position of the foreground image or the background image in accordance with the position of the virtual viewpoint or for each virtual viewpoint image to be generated. Also with such processing, it is expected that the estimation accuracy of the shape of the foreground object is reduced.

The color, shape, or arrangement of the foreground object may vary in accordance with the position of the designated viewpoint or for each virtual viewpoint image to be generated in accordance with determining that the plurality of pieces of information satisfy the predetermined condition. For example, the blocking processing unit 63 can perform translation, enlargement, reduction, or rotation processing with respect to the foreground object. Such processing enables the blocking processing unit 63 to slightly change the positional relationship between the background object and the foreground object in accordance with the position of the virtual viewpoint. FIG. 5 illustrates an example of slightly translating a foreground object arranged in a virtual space from a position 510 to a position 520. The positional relationship between the foreground object and a background object 530 is changed by the translation. Such processing makes reconstruction of the three-dimensional shape of a foreground object using the virtual viewpoint video difficult. For example, such processing can disturb processing of estimating the position and attitude of the camera using the photogrammetry technology. The blocking processing unit 63 may change the texture of the foreground object.

Similarly, the blocking processing unit 63 may change the color, shape, or position of the background object in accordance with determining that the plurality of pieces of information satisfy the predetermined condition. For example, the blocking processing unit 63 may change the color, shape, or position of the background object in accordance with the position of the virtual viewpoint or for each virtual viewpoint image to be generated. With such a configuration, it is expected that the estimation accuracy of the shape estimated for the background object is reduced. It is expected that the estimation accuracy of the shape of the foreground object is also reduced due to the background object thus estimated attaching to the foreground object. For example, the blocking processing unit 63 can perform translation, enlargement, reduction, or rotation processing with respect to the background object. Also with such processing, the positional relationship between the background object and the foreground object changes.

The blocking processing unit 63 may change the positional relationship among a plurality of objects in accordance with determining that the plurality of pieces of information satisfy the predetermined condition. The plurality of objects can include a foreground object, a background object, and a blocker object. For example, the positional relationship between the foreground object and the background object, the positional relationship between the foreground object and the blocker object, or the positional relationship between the plurality of foreground objects may change in accordance with the position of the virtual viewpoint or for each virtual viewpoint image to be generated. The blocking processing unit 63 can change the positional relationship among the plurality of objects by performing translation, enlargement, reduction, or rotation processing with respect to at least one object.

In accordance with determining that the plurality of pieces of information satisfy the predetermined condition, the blocking processing unit 63 may perform processing of reducing resolution or sharpness with respect to the virtual viewpoint image generated by the generation processing unit 62. For example, the blocking processing unit 63 can perform blur processing with respect to a virtual viewpoint image. Specifically, in a case where the virtual viewpoint moves while the time is stopped, the blocking processing unit 63 can apply motion blur with respect to a virtual viewpoint image. According to such a configuration, it is possible to reduce the resolution of the virtual viewpoint image while suppressing the sense of incongruity felt by the user. The blocking processing unit 63 may forcibly add blur with respect to a virtual viewpoint image by a method such as shifting a focus position. The blocking processing unit 63 may change the transparency of the foreground object. The blocking processing unit 63 can reduce the sharpness of the virtual viewpoint image by increasing the transparency to such an extent that the sense of incongruity felt by the user does not increase. Furthermore, the blocking processing unit 63 may superimpose noise such as block noise with respect to a virtual viewpoint image. When such processing is performed, the user can feel that the transmission band has decreased. Therefore, it is possible to suppress the user's sense of incongruity at the time of reducing the resolution or sharpness.

In accordance with determining that the plurality of pieces of information satisfy the predetermined condition, the blocking processing unit 63 can apply a visual effect to the virtual viewpoint image generated by the generation processing unit 62. For example, the blocking processing unit 63 can apply an effect such as lens flare, ghost, glow, or glare. Adding such processing can make the contour of the subject ambiguous. Also, one can expect that a different effect depending on the position of a virtual viewpoint is superimposed on a foreground object. Therefore, it is possible to disturb the reconstruction of the three-dimensional shape of the foreground object using photogrammetry or the like. The user can take such an effect as a production when the time is stopped. Therefore, it is possible to suppress the user's sense of incongruity.

In accordance with determining that the plurality of pieces of information satisfy the predetermined condition, the blocking processing unit 63 may superimpose invisible noise with respect to the virtual viewpoint image generated by the generation processing unit 62. With such processing, it is expected to make it difficult to reconstruct the shape of the foreground object from the virtual viewpoint video using a machine learning technology.

So far, various types of processing by the blocking processing unit 63 for making it difficult to estimate the three-dimensional shape of the object have been described. The blocking processing unit 63 may also use a combination of processing described above. By combining a plurality of processes, it is more difficult to estimate the three-dimensional shape of the object. The blocking processing unit 63 may switch a plurality of processes.

In the above-described embodiment, in a case where it is determined that the plurality of pieces of information satisfy the predetermined condition, the blocking processing unit 63 performs processing for making it difficult to estimate the three-dimensional shape of the object. However, the condition under which the blocking processing unit 63 performs processing is not limited to that described above. For example, the operation detection unit 61 may determine whether or not a plurality of pieces of virtual viewpoint information satisfy a predetermined condition. The predetermined condition may be, for example, that a virtual viewpoint turns around a specific foreground object. In this case, when the user operates the virtual viewpoint so as to create a virtual viewpoint video from various directions of a foreground object, processing by the blocking processing unit 63 is performed. Furthermore, the blocking processing unit 63 may perform processing for making it difficult to estimate the three-dimensional shape of the object at all times. According to such a configuration, it is possible to make it difficult to estimate the three-dimensional shape of a background object that does not change with time. At this time, the blocking processing unit 63 may switch a plurality of blocking displays according to the production.

By the method explained earlier, the generation processing unit 62 can generate a plurality of virtual viewpoint images including an object corresponding to an identical designated time in accordance with information indicating the time corresponding to the object, the position of a virtual viewpoint, and the line-of-sight direction from the virtual viewpoint. In one embodiment, the color, shape, or arrangement of an object in a virtual space varies between the plurality of generated virtual viewpoint images. As explained earlier, such an embodiment can be achieved by changing the color, shape, or arrangement of an object such as a foreground object, a background object, or a blocker object in accordance with the position of the designated viewpoint or for each virtual viewpoint image to be generated. For example, the color, shape, or arrangement of the object may be different for each direction of the virtual viewpoint. According to such an embodiment, as described above, reconstruction of the three-dimensional shape of an object using the virtual viewpoint video is made difficult. Such processing may be performed in accordance with determining that the plurality of pieces of information satisfy the predetermined condition. On the other hand, such processing may be performed regardless of whether the plurality of pieces of information satisfy the predetermined condition. For example, such processing may be performed at all times. In a case where such processing is performed at all times, the color, shape, or arrangement of the object can be changed so as not to be easily perceived by the user.

### Other Embodiments

Each processing unit included in the image processing apparatus illustrated in FIG. 1 can be implemented by hardware. On the other hand, the function of each processing unit may be implemented by a computer program. For example, the image processing apparatus according to the above-described embodiment can be implemented by a computer including a processor and a memory. The image processing apparatus may include, for example, a plurality of information processing apparatuses connected via a network. For example, the function of the image processing apparatus may be provided as a cloud service.

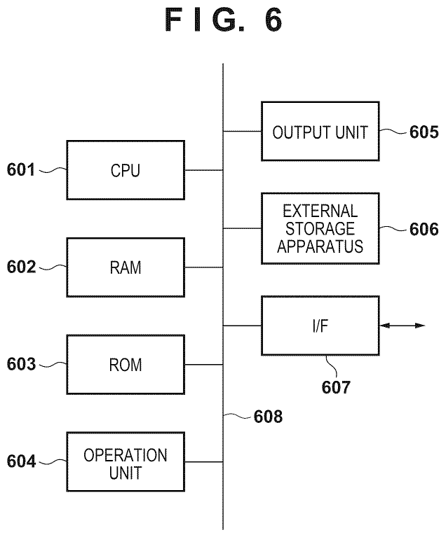

FIG. 6 is a block diagram illustrating a hardware configuration example of a computer that can be used as an image processing apparatus according to one embodiment. A CPU 601 controls the entire computer using a computer program or data stored in a RAM 602 or a ROM 603. The CPU 601 executes processing performed by each processing unit included in the image processing apparatus. That is, the CPU 601 can function as each processing unit included in the image processing apparatus.

The RAM 602 has an area for temporarily storing a computer program or data read from an external storage apparatus 606. The RAM 602 can also store data acquired from an outside via an interface (I/F) 607. The RAM 602 provides a work area used when the CPU 601 executes processing. For example, the RAM 602 may provide a memory region such as a frame memory.

The ROM 603 stores setting data, a boot program, and the like. An operation unit 604 inputs various types of instructions in accordance with a user operation to the CPU 601. The operation unit 604 may be a keyboard, a mouse, or the like. An output unit 605 displays a processing result obtained by the CPU 601. The output unit 605 is, for example, a liquid crystal display. The operation unit 604 can function as the viewpoint instruction unit 5. The output unit 605 can function as the display unit 7.

The external storage apparatus 606 stores a computer program of an operating system (OS) and a computer program for causing the CPU 601 to implement the function of each processing unit of the image processing apparatus. The external storage apparatus 606 can function as the storage unit 4 that stores material data. The external storage apparatus 606 may be a large-capacity information storage apparatus such as a hard disk drive.

In this manner, a processor such as the CPU 601 executes a program stored in a memory such as the RAM 602, the ROM 603, or the external storage apparatus 606, whereby the function of each processing unit of the information processing apparatus can be implemented. For example, a computer program or data stored in the external storage apparatus 606 is loaded, as appropriate, into the RAM 602 under the control of the CPU 601. The program or data loaded into the RAM 602 is a processing target by the CPU 601.

A network such as a LAN or the Internet, or other equipment such as a projection apparatus or a display apparatus can be connected to the I/F 607. The image processing apparatus can transmit and receive various types of information via the I/F 607. The capturing unit 1 and the user terminal 10 may be connected to the I/F 607. In this case, a captured image and operation information are input via the I/F 607. The image processing apparatus can, via the I/F 607, control the capturing unit 1 or transmit an image to be displayed on the display unit 7. A bus 608 connects the above-described units.

According to one embodiment of the present disclosure, it is possible to make it difficult to estimate a three-dimensional shape of a subject based on a generated virtual viewpoint image in a technology of generating a virtual viewpoint image of the subject.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-225569, filed Dec. 20, 2024, which is hereby incorporated by reference herein in its entirety.

What is claimed is:

1. An image processing apparatus comprising one or more memories storing instructions and one or more processors that execute the instructions to:
obtain a plurality of pieces of information, wherein one piece of information indicates a time corresponding to an object, a position of a virtual viewpoint, and a line-of-sight direction from the virtual viewpoint;
determine whether or not the plurality of pieces of information satisfy a predetermined condition; and
generate a virtual viewpoint image corresponding to the virtual viewpoint and including an object corresponding to the time based on each of the plurality of pieces of information such that a virtual viewpoint image to be generated changes in accordance with a result of the determination.

2. The image processing apparatus according to claim 1, wherein the predetermined condition is satisfied in a case where a time stops, a time changes at a speed of a threshold or less, or a same time is repeated.

3. The image processing apparatus according to claim 1, wherein the one or more processors execute the instructions to make a change to the virtual viewpoint image such that reconstruction of a three-dimensional shape of the object based on the virtual viewpoint image becomes more difficult in accordance with determining that the plurality of pieces of information satisfy the predetermined condition.

4. The image processing apparatus according to claim 1, wherein the one or more processors execute the instructions to add a three-dimensional object as an additional object in accordance with determining that the plurality of pieces of information satisfy the predetermined condition.

5. The image processing apparatus according to claim 4, wherein a color of the additional object in the virtual viewpoint image changes in accordance with a position of the virtual viewpoint.

6. The image processing apparatus according to claim 4, wherein the additional object includes a mirror surface.

7. The image processing apparatus according to claim 4, wherein the additional object has characteristics different from characteristics of an object in real space.

8. The image processing apparatus according to claim 4, wherein the additional object includes a surface visible from an internal side of the additional object and is invisible from an external side of the additional object.

9. The image processing apparatus according to claim 4, wherein color, shape, or arrangement of the additional object in a virtual space varies in accordance with a position of the virtual viewpoint or for each virtual viewpoint image to be generated.

10. The image processing apparatus according to claim 4, wherein the one or more processors execute the instructions to arrange the additional object such that a specific surface of the additional object faces the virtual viewpoint.

11. The image processing apparatus according to claim 1, wherein the one or more processors execute the instructions to superimpose an additional image onto the virtual viewpoint image in accordance with determining that the plurality of pieces of information satisfy the predetermined condition.

12. The image processing apparatus according to claim 11, wherein the additional image is a watermark image.

13. The image processing apparatus according to claim 1, wherein, in accordance with determining that the plurality of pieces of information satisfy the predetermined condition, color, shape, or arrangement of the object in a virtual space varies in accordance with a position of the virtual viewpoint or for each of the virtual viewpoint images to be generated.

14. The image processing apparatus according to claim 1, wherein the one or more processors execute the instructions to generate a virtual viewpoint image corresponding to the virtual viewpoint and including an object corresponding to the time and a background object by using three-dimensional shape data of the background object, and
in accordance with determining that the plurality of pieces of information satisfy the predetermined condition, color, shape, or arrangement of the background object in a virtual space, or a positional relationship between the object and the background object varies in accordance with a position of the virtual viewpoint or for each of the virtual viewpoint images to be generated.

15. The image processing apparatus according to claim 1, wherein the one or more processors execute the instructions to perform processing of reducing resolution or sharpness with respect to the virtual viewpoint image in accordance with determining that the plurality of pieces of information satisfy the predetermined condition.

16. The image processing apparatus according to claim 1, wherein the one or more processors execute the instructions to acquire, from a storage storing three-dimensional shape data and a texture image of the object corresponding to each of a plurality of times, three-dimensional shape data of the object and a plurality of texture images of the object corresponding to the times, and generate the virtual viewpoint image using the three-dimensional shape data and the texture images.

17. An image processing apparatus comprising one or more memories storing instructions and one or more processors that execute the instructions to:
obtain a plurality of pieces of information, wherein one piece of information indicates a time corresponding to an object, a position of a virtual viewpoint, and a line-of-sight direction from the virtual viewpoint; and
generate a virtual viewpoint image corresponding to the virtual viewpoint and including an object corresponding to the time based on each of the plurality of pieces of information such that color, shape, or arrangement of the object in a virtual space varies among a plurality of virtual viewpoint images including the object corresponding to an identical time.

18. An image processing method comprising:
obtaining a plurality of pieces of information, wherein one piece of information indicates a time corresponding to an object, a position of a virtual viewpoint, and a line-of-sight direction from the virtual viewpoint;
determining whether or not the plurality of pieces of information satisfy a predetermined condition; and
generating a virtual viewpoint image corresponding to the virtual viewpoint and including an object corresponding to the time based on each of the plurality of pieces of information such that a virtual viewpoint image to be generated changes in accordance with a result of the determination.

19. A non-transitory computer-readable medium storing a program executable by a computer to perform a method comprising:
obtaining a plurality of pieces of information, wherein one piece of information indicates a time corresponding to an object, a position of a virtual viewpoint, and a line-of-sight direction from the virtual viewpoint;
determining whether or not the plurality of pieces of information satisfy a predetermined condition; and
generating a virtual viewpoint image corresponding to the virtual viewpoint and including an object corresponding to the time based on each of the plurality of pieces of information such that a virtual viewpoint image to be generated changes in accordance with a result of the determination.
